(19) United States
(12) Patent Application Publication
(10) Pub. No.: US 2021/0398046 A1
(43) Pub. Date: Dec. 23, 2021

(54) Predictive Modeling Technologies for Identifying Retail Enterprise Deficiencies

(71) Applicant: Spark Resultants LLC, New York, NY (US)

(72) Inventors: Johnny Custer, Lantana, TX (US); Andrew Grimes, Mesa, AZ (US); Ernie Deyle, St. Charles, IL (US)

(21) Appl. No.: 17/347,945

(22) Filed: Jun. 15, 2021

Related U.S. Application Data
(60) Provisional application No. 63/040,040, filed on Jun. 17, 2020.
(60) Provisional application No. 63/055,596, filed on Jul. 23, 2020.

(51) Int. Cl. G06Q 10/06; G06N 20/20

(52) U.S. Cl. CPC G06Q 10/06315; G06N 20/20; G06Q 10/06395; G06Q 10/06375

(57) ABSTRACT

Technologies are provided for predictive modeling potential issues that may arise in a retail store enterprise and offer remedies to address the issues. The system includes machine learning model(s) that proactively isolate systematic problems in a retail store enterprise, such as operational deficiencies, breakdowns in training, and execution failures that lead to negative sales/margin impact. In some embodiments, the system leverages artificial intelligence to create actionable leading indicators and high-confidence predictive models. These indicators allow the system to facilitate a determination of the genesis or “root cause” of these issues and how to “course correct.”

### RELATED APPLICATIONS

This application claims the benefit of U.S. Provisional Application Ser. No. 63/055,596 filed Jul. 23, 2020 and U.S. Provisional Application Ser. No. 63/040,040 filed Jun. 17, 2020, which are both hereby incorporated by reference in their entireties.

### BACKGROUND

The retail space, be it traditional brick and mortar customer facing establishments and/or variations of online customer facing elements of a retailer business, all have one thing in common: everything is “transactional.” The term “transactional” means, every task, interaction, process, event, and/or interaction generates a data file that can be analyzed to determine a variety of insights. These insights can be as basic as identifying when a task was not executed, and/or when a task was started but not completed. Most rudimentary store systems are capable of reporting these basic operational activities. However, virtually of all of their reporting is reactionary by design, as financial performance is based on a physical inventory result that is posted to the financial system. Once posted to the financial system this leaves the executive team with limited options to correct the opportunities. There is a need for a system that proactively assesses the operational execution and performance of their stores before financial results are posted.

### SUMMARY

According to one aspect, this disclosure provides a system for predicting retail enterprise deficiencies. The system includes a storage device and at least one processor. The storage device has stored front store data, center store data, and back store data of a plurality of stores of a retail store enterprise. The front store data comprises customer facing data at a point of purchase system. The center store data includes data regarding one or more of inventory sales data, visual merchandising set data, price integrity data, price file management data, or inventory management system data. The back store data comprises data representing inbound and outbound flow of products between one or more of internal distribution centers, direct to store shipments, or drop shipments. The storage device stores a program for controlling the at least one processor. The program is configured to create a plurality of machine learning (ML) models for predicting executional gaps regarding one or more of the front store data, center store data or back store data by analyzing training data representative of historical transactions concerning front store data, center store data and back store data of at least a portion of the plurality of stores of the retail store enterprise. The program scores a plurality of leading indicators concerning the front store data, center store data and back store data as a function of respective stores in the retail store enterprise based on the plurality of ML models. In some embodiments, scoring the plurality of leading indicators includes predicting future performance regarding the plurality of leading indicators regarding the plurality of stores of the retail store enterprise. The program generates a user interface highlighting one or more issues that need addressing based on the score of the plurality of leading indicators.

According to another aspect, this disclosure provides a method of predicting retail enterprise deficiencies. The method includes the step of creating a plurality of machine learning (ML) models for predicting executional gaps regarding one or more of a front store data, a center store data or a back store data by analyzing training data representative of historical transactions concerning front store data, center store data and back store data of at least a portion of the plurality of stores of the retail store enterprise. There is a step of scoring a plurality of leading indicators concerning the front store data, center store data and back store data as a function of respective stores in the retail store enterprise based on the plurality of ML models. In some embodiments, scoring the plurality of leading indicators includes predicting future performance regarding the plurality of leading indicators regarding the plurality of stores of the retail store enterprise. The method also includes generating a user interface highlighting one or more issues that need addressing based on the score of the plurality of leading indicators.

According to a further aspect, this disclosure provides one or more non-transitory, computer-readable storage media with a plurality of instructions stored thereon that, in response to being executed, cause a computing device to (i) store front store data, center store data, and back store data of a plurality of stores of a retail store enterprise, wherein the front store data comprises customer facing data at a point of purchase system, the center store data comprises data regarding one or more of inventory sales data, visual merchandising set data, price integrity data, price file management data, or inventory management system data, and the back store data comprises data representing inbound and outbound flow of products between one or more of internal distribution centers, direct to store shipments, or drop shipments, (ii) create a plurality of machine learning (ML) models for predicting executional gaps regarding one or more of the front store data, center store data or back store data by analyzing training data representative of historical transactions concerning front store data, center store data and back store data of at least a portion of the plurality of stores of the retail store enterprise; (iii) score a plurality of leading indicators concerning the front store data, center store data and back store data as a function of respective stores in the retail store enterprise based on the plurality of ML models, wherein to score the plurality of leading indicators comprises predicting future performance regarding the plurality of leading indicators regarding the plurality of stores of the retail store enterprise; and (iv) generate a user interface highlighting one or more issues that need addressing based on the score of the plurality of leading indicators.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for predictive modeling;

FIG. 2 is a simplified flow diagram of at least one embodiment of a method for predicting retail enterprise issues that need addressing and suggesting remedies for addressing the identified issues;

FIGS. 3A and 3B illustrate example user interfaces for leading indicator reports according to an embodiment of this disclosure;

FIG. 4 illustrates an example user interface illustrating an example leading indicator score card in which predictive models are aggregated for a district of stores according to a according to an embodiment of this disclosure;

FIG. 5 illustrates an example user interface illustrating an example heat map for a district of stores identifying risk levels based on predictive models according to an embodiment of this disclosure;

FIG. 6 illustrates an example user interface illustrating a predictive modeling scorecard for a district of stores identifying risk levels according to an embodiment of this disclosure;

FIG. 7 illustrates an example user interface illustrating an example alert according to an embodiment of this disclosure;

FIG. 8 illustrates an example user interface illustrating a leading indicator data for a district of stores identifying risk levels according to an embodiment of this disclosure;

FIGS. 9A and 9B illustrates an example user interface that presents options to identify a root cause of behavior driving the leading indicator performance; and

FIG. 10 is a simplified flow diagram of at least one embodiment of a predictive modeling system for retail enterprises.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

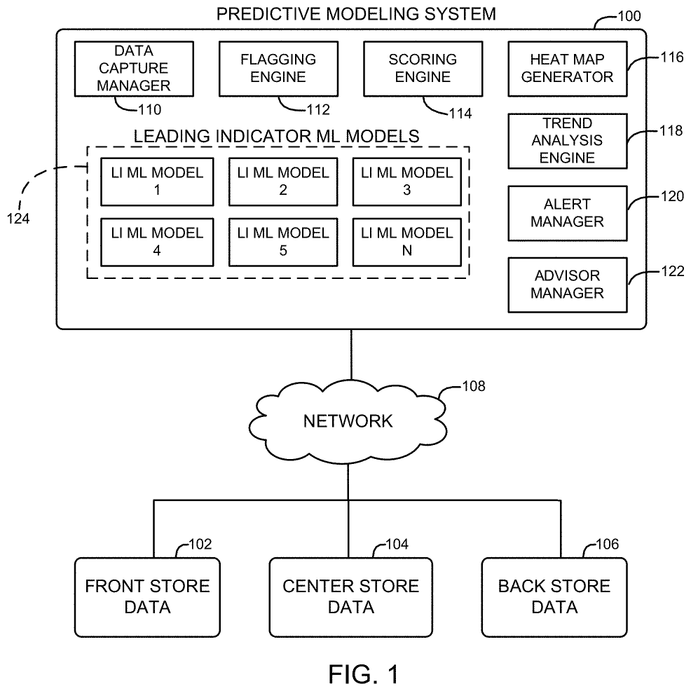

Referring now to FIG. 1, a system 100 for predictive modeling potential issues that may arise in a retail store enterprise and offer remedies to address the issues. In use, as described further below, the system 100 includes machine learning model(s) that proactively isolate systematic problems in a retail store enterprise, such as operational deficiencies, breakdowns in training, and execution failures that lead to negative sales/margin impact. In some embodiments, the system 100 leverages artificial intelligence to create actionable leading indicators and high-confidence predictive models. These indicators allow the system 100 to facilitate a determination of the genesis or “root cause” of these issues and how to best “course correct.” The system 100 may be embodied as any type of computation or computer device capable of performing the functions described herein, including, without limitation, a computer, a server, a workstation, a desktop computer, a laptop computer, a notebook computer, a tablet computer, a mobile computing device, a wearable computing device, a network appliance, a web appliance, a distributed computing system, a processor-based system, and/or a consumer electronic device.

The system 100 has access to a variety of data generated by one or more stores in a retail store enterprise. In the example shown, the system 100 has access to front store data 102, center store data 104, and back store data over a network 108. The front store data 102 may include, but is not limited to point of sale system data, e-commerce data, stock ledger data, sales audit data, and finance data generated by one or more stores in the retail enterprise. The center store data 104 may include, but is not limited to pricing files, markups/markdowns data, warehouse management system (WMS) inventory data, perpetual inventory data, and item movement data. The back store data 106 may include one or more of inbound/outbound data, cross dock data, direct store delivery (DSD), and/or wholesale delivery data. Depending on the circumstances, additional data or only a subset of the front store, center store and back store data 102, 104, 106 may be available to the system 100. The system 100 may be configured to transmit and receive data with other devices having stored front store data 102, center store data 104, and/or back store data 106 over the network 108. The network 108 may be embodied as any number of various wired and/or wireless networks. For example, the network 108 may be embodied as, or otherwise include, a wired or wireless local area network (LAN), and/or a wired or wireless wide area network (WAN). As such, the network 108 may include any number of additional devices, such as additional computers, routers, and switches, to facilitate communications with the system 100.

As shown, the system 100 establishes an environment during operation to predict potential issues in the retail store enterprise and offer remedies to address the issues. In some environments, the system 100 includes a data capture manager 110, a flagging engine 112, a scoring engine 114, a heat map generator 116, a trend analysis engine 118, an alert manager 120, an advisor manager 122, and a plurality of leading indicator ML models 124. There are a variety of leading indicator ML models that can be created for predictions for a plurality of leading indicators that are correlated to profit and loss for prioritization. For example, the leading indicator ML models 124 could be based on one or more of:

Front Store

Composite SRA

Composite SCA

Cashier Performance Composite

Cash Over/Short Performance

Gross Margin index

Financial Scorecard

Pre-employment screening rate

Composite turnover

Churn

Wage Attachment/Garnishments

FT/PT ratio equivalent

Center Store

Baseline/Operational/APP/PA Audit

PIG (Pure Inventory Growth)

IDM Inventory Data Model

Markdowns—(Promotional and Clearance, Store and Corp Initiated)

Clearance Batch Activation Rates

Inter-Store Transfers

Intra-Store Transfers

Refrigeration system(s) Performance

Perishables Composite

Back Store

Training/certification Compliance

Damage Reclamation

Supply chain

IRED (Invoice Risk Evaluation Data)

Workers Comp/General Liability

Hazardous material processing

As shown, the various components of the environment may be embodied as hardware, firmware, software, or a combination thereof. As such, in some embodiments, one or more of the components of the environment may be embodied as circuitry or collection of electrical devices (e.g., data capture manager circuitry 110, a flagging engine circuitry 112, a scoring engine circuitry 114, a heat map generator circuitry 116, a trend analysis engine circuitry 118, an alert manager circuitry 120, an advisor manager circuitry 122). Additionally, in some embodiments, one or more of the illustrative components may form a portion of another component and/or one or more of the illustrative components may be independent of one another.

The data capture manager 110 is configured to capture data from which the predictions can be made by the system 100. For example, the data capture manager may be configured to access the front store, center store, and back store data 102, 104, 106. The data capture manager may then store the data 102, 104, 106 on a storage device for access by the system 100. Depending on the circumstances, the data capture manager 110 could periodically retrieve the data 102, 104, 106, such as daily, weekly, etc.

The flagging engine 112 is configured to assign a flag to various metrics, such as stores, departments, categories, SKUs, etc. based on trending predictions of the ML models 124 related to that metric. In some embodiments, the flagging engine 112 assigns a flag to metrics based on a pattern or trend identified by one or more ML models 124. For example, the flagging engine 112 may assign a flag to a trend or pattern that indicates action is required, which raises attention to the issue. The flagging engine may flag both positive and negative trends or patterns to draw attention.

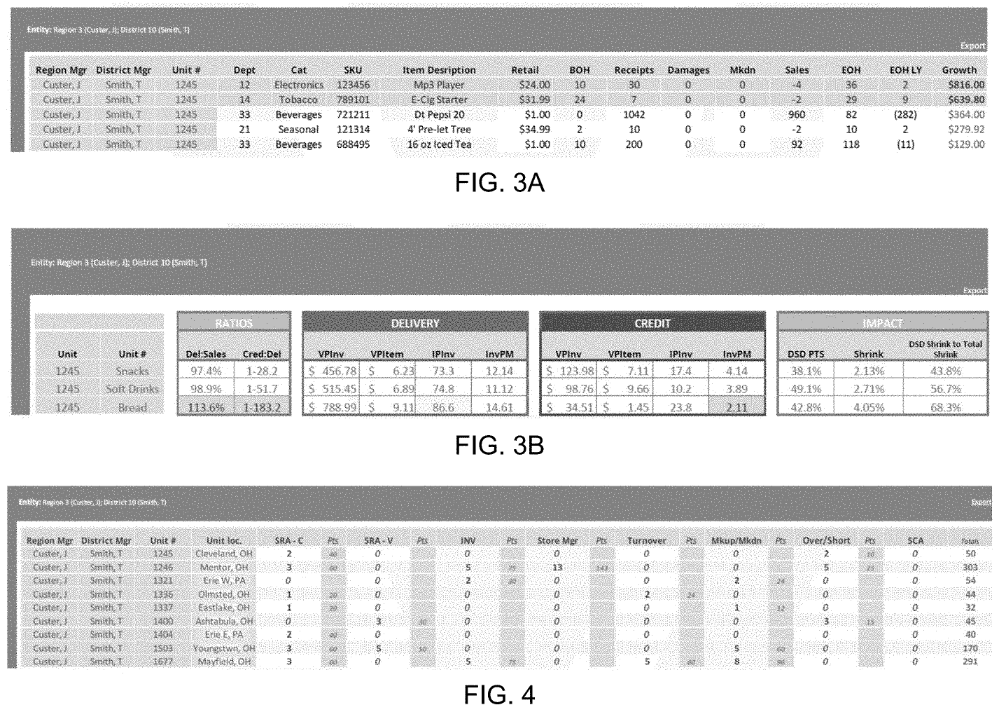

FIGS. 3A and 3B illustrate leading indicator reports that could be generated by the flagging engine. This example involves “Store 1245” in “Region 3” and “District 10” merely for purposes of illustration. As shown, the report involves a plurality of columns containing relevant information about a leading indicator. In this example, SKU “123456” for an MP3 player and SKU “789101” for an E-Cig Starter have been flagged by the flagging engine 112 based on one or more ML models 124 as having a trend that requires action. Similarly, in FIG. 3B, there are metrics for “Bread” that have been identified by the flagging engine 110 based on one or more ML models that require attention. The reports shown are for illustrative purposes only. In some embodiments, similar reports could be provided for each of the leading indicators referenced above with regard to the ML models 124.

Referring again to FIG. 1, the scoring engine 114 is configured to tally and weigh each flag based on the correlation of each leading indicators' correlation to the store's performance. For example, a number of flags for each leading indicator may have different weights, thereby contributing different amounts to the overall store's score.

FIG. 4 illustrates an example report that could be generated by the scoring engine 114. In this example, the report view is for a district with a plurality of stores for a retail enterprise. In the example shown, the Store Number is under the “Unit #” column on the report and there is a “Unit loc.” that identifies the city in which the store is located. In this example, the report contains the following leading indicators, SRA-C, SRA-V, INV, Store Mgr, Turnover, Mkup/Mkdn, Over/Short, and SCA for purposes of example. Each leading indicator is arranged in a column on the report and there is a number for each store that indicates the number of flags for that store regarding that leading indicator. For example, Store 1677 received 3 flags for SRA-C, 5 flags for INV, 5 flags for Turnover, and 8 flags for Mkup/Mkdn. Each of the leading indicators is weighted based on correlation of that respective leading indicator to the store's performance. For example, Store 1677 received 3 flags for SRA-C, which are weighted at 20 points each, for a total SRA-C store of 60. However, each of the 5 flags for INV are weighted at 15 for a total INV score of 75. The total points for each store are aggregated in the “Totals” column.

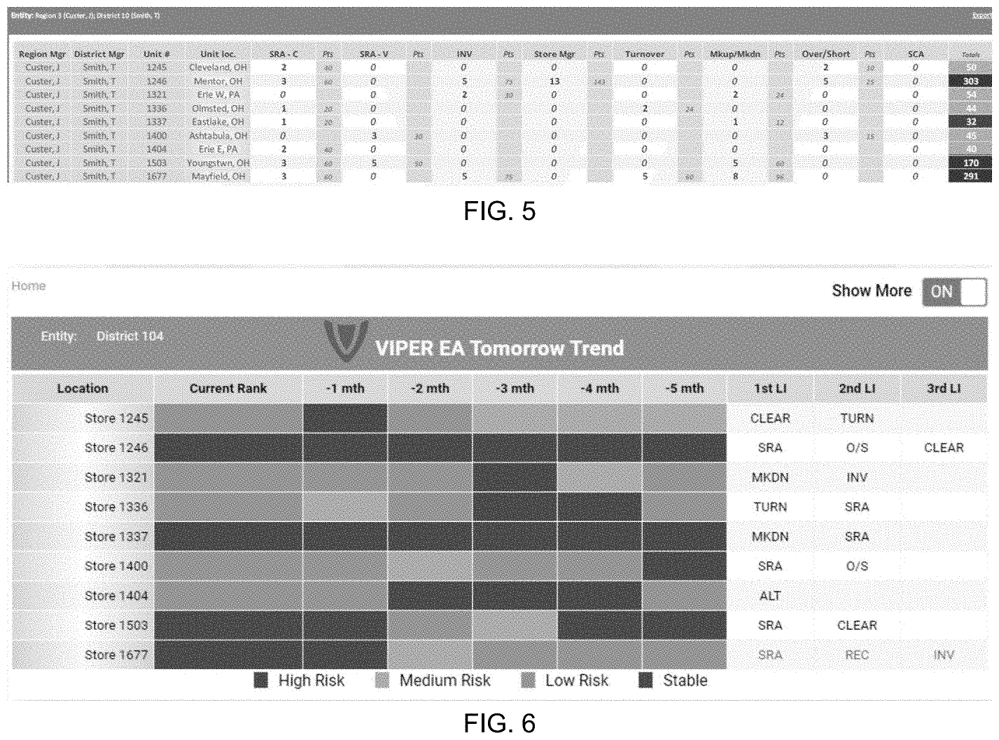

Referring again to FIG. 1, the heat map generator 116 is configured to generate a risk rating or heat-mapping designation for each store that identifies a risk level based on one or more ML models 124. For example, the risk rating could be a score based on the weighted total of leading indicators based on the ML models 124. In some embodiments, the higher the risk score, the higher the risk and higher priority of issues that need to be addressed. FIG. 5 illustrates an example report that could be generated by the heat map generator 116. This is similar to the report shown in FIG. 4, but here the point totals column for each store are color-coded based on risk. In the example shown, there are 4 color codes, with 121 and above being in red, 80-120 being in yellow, 40-79 being in light green, and 1-39 being in dark green. Although these colors are shown for purposes of example, more or less categories could be provided depending on the circumstances; likewise, different colors could be provided for coding with different meanings.

The trend analysis engine 118 is configured to generate an interactive scorecard for each store based on predictions of the ML models 124 regarding the future performance of each store into the future. FIG. 6 illustrates an example predictive scorecard that could be generated by the trend analysis engine 118. In the example, the scorecard includes a plurality of columns with a “Current Rank” and then predictions extending along a time horizon, which in this example is on a monthly basis. As shown, there is a “−1 mth” column that indicates predicted performance for the next month in the future; a “−2 mth” column for the prediction 2 months into the future, “−3 mth” column for the prediction 3 months into the future, a “−4 mth” column for 4 months into the future, and a “−5 mth” column for the prediction 5 months into the future. The scorecard provides a high level overview of trends for the stores so managers can determine where to focus attention to proactively address issues that may be causing the predictive trends. For example, with Store 1245 in the example, a manager can see a negative predictive trend 3 months into the future and attempt to address the issue prior to the prediction becoming a reality. Depending on the circumstances, there could be additional columns for additional predictions by the ML models 124 further into the future. Although the example scorecard shown in FIG. 6 provides predictions on a monthly basis into the future, another time increment could be used, such as weekly, daily, quarterly, etc.

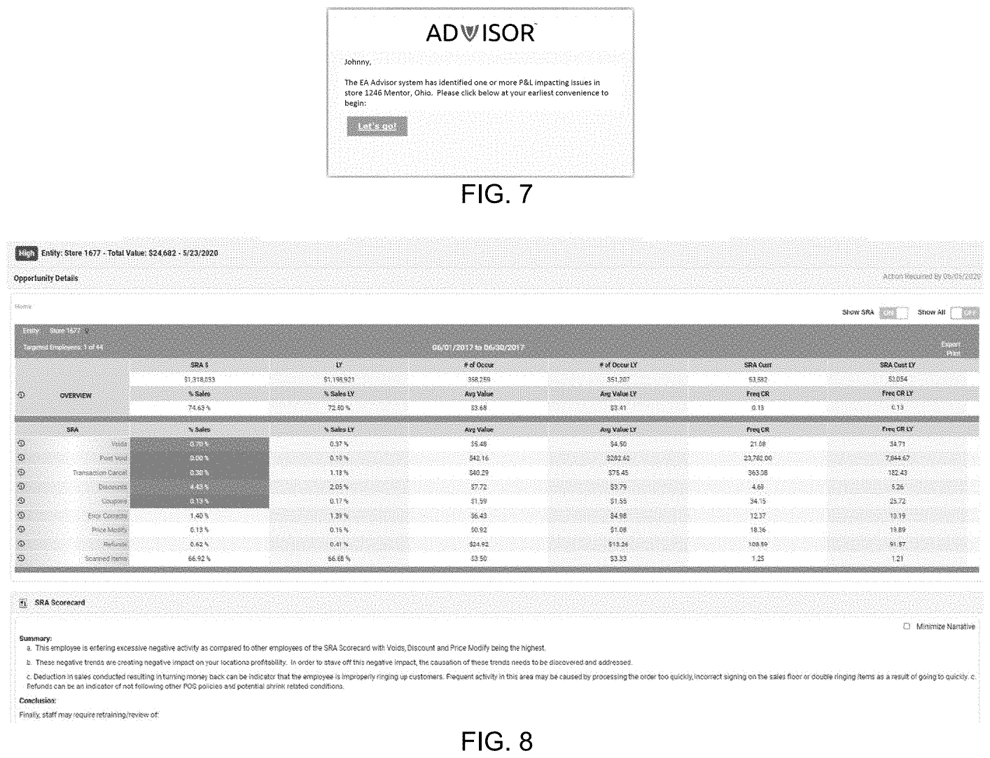

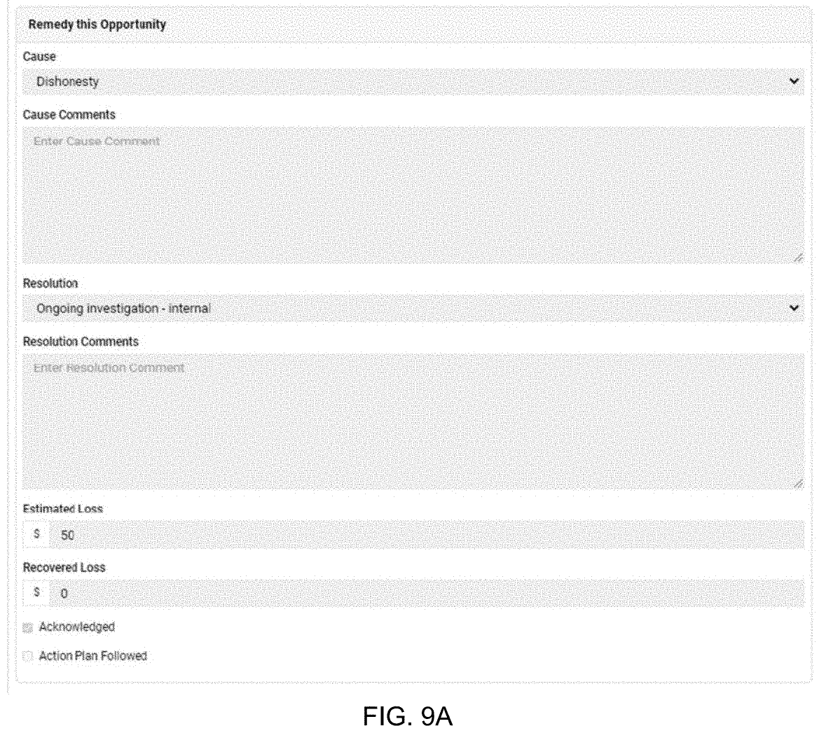

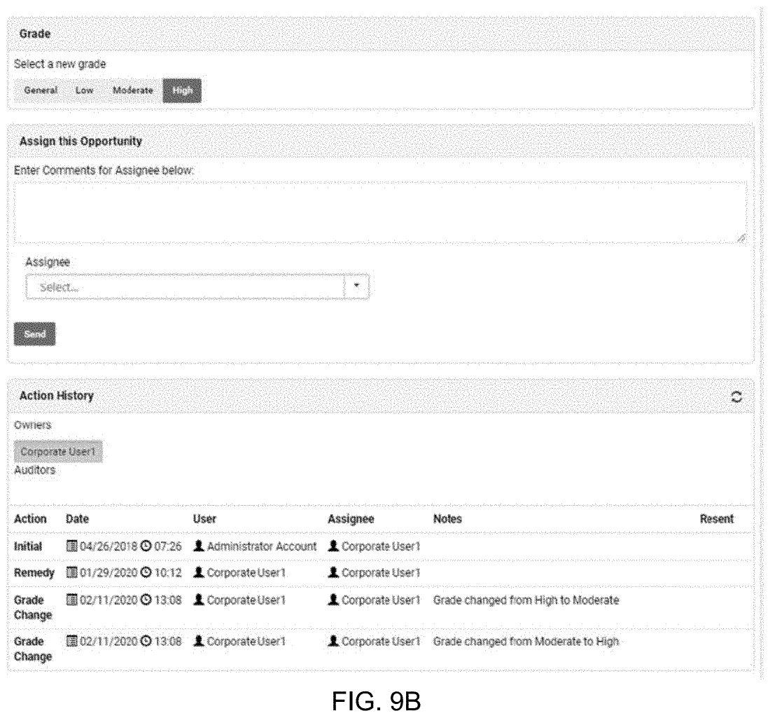

The alert manager 120 is configured to send out an alert to a predetermined set of persons, such as field managers. In some embodiments, the alert includes targeted information that identifies one or more stores that are identified by the ML models 124 as predicting trends to negative performance. These alerts could be sent at a pre-determined cadence and/or based on trends at stores managed by the identified manager in the predetermined set of persons. These alerts allow managers to ensure that they are visiting stores that require attention, and addressing issues that have a direct P&L impact. FIG. 7 illustrates an example alert that could be sent by the alert manager 120. In the example shown, the alert identifies a specific store, Store 1246 in Mentor, Ohio, as a store identified in which the ML models 124 have predicted an impact to P&L issues. There is a hyperlink in the message text “Let's go!” that directs the user to a report similar to that shown in FIG. 8, which could be generated by the advisor manager 122. In the example shown, the pertinent leading indicator data is shown in a format with drill-down capability. Additionally, there may be instructions pre-populated based on the type of indicator being shown. As the user scrolls down the example interface shown in FIG. 8, the user is presented with an interface shown in FIGS. 9A and 9B in which the user is presented with a number of options/functions to remedy the issue. This interface guides the user through specific resolution and the dollar values of a rectified issue.

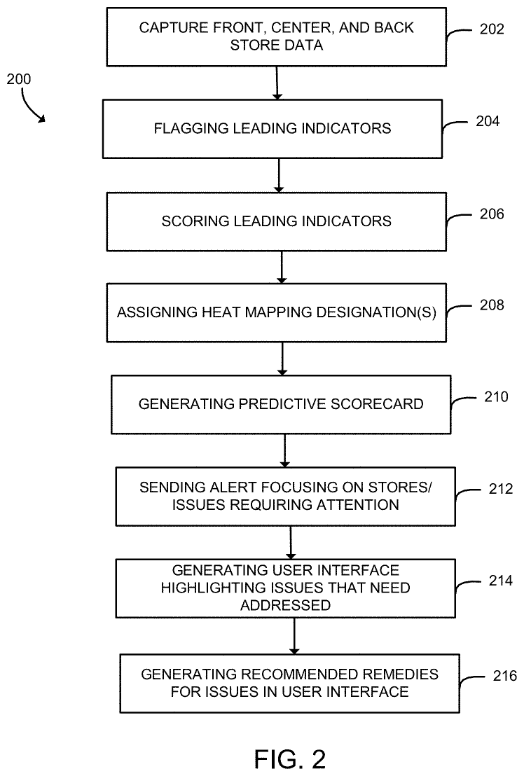

Referring back to FIG. 2, there is shown a method 200 that may be executed by one or more portions of the 100 as described herein. As shown, the method 200 starts at block 202 in which the front, center, and back store data 102, 104, 106 are captured. Next, the method 200 advances to block 204 in which the leading indicators are identified and flagged based on P&L for prioritization reporting and predictive modeling. The method 200 proceeds to block 206 in which the leading indicators are scored based on the weighting of respective leading indicators, which allows a user to identify the stores with the most pressing issues that need addressed. Next, the method 200 continues to block 208 in which heat map designations (or other categorization) are assigned. The method 200 then advances to block 210 in which a predictive scorecard is generated that identifies trends for a plurality of stores. Next, the method 200 progresses to block 212 in which an alert is sent to a predetermined set of persons that identify stores that require focus. The method 200 advances to blocks 214 and 216 in which the system provides a user interface that highlights issues that need to be addressed and generates recommended remedies to the issues.

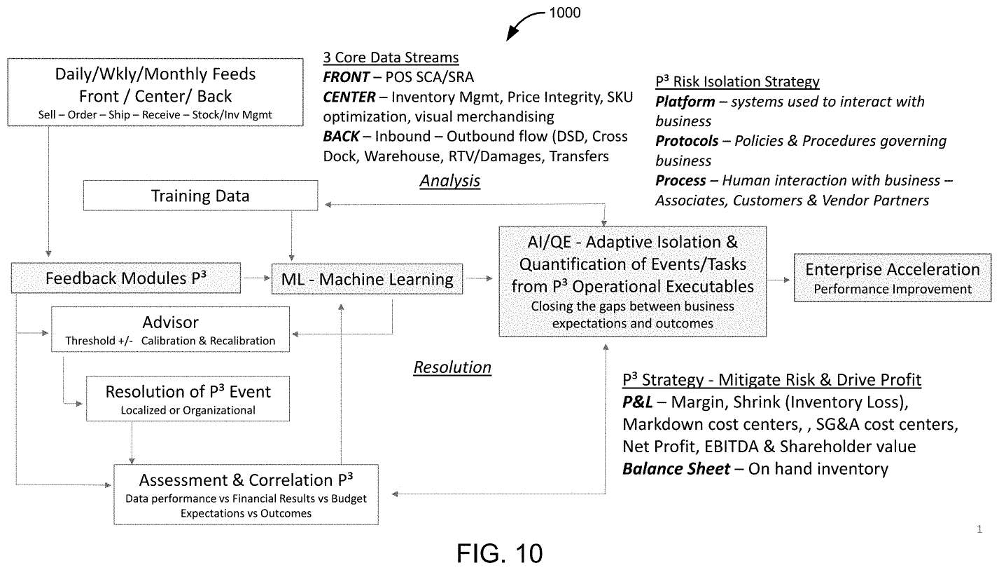

Referring now to FIG. 10, there is shown an example embodiment of the system 100. As discussed herein, the system 1000 provides insights to the executive team by delivering targeted actionable information that isolates and quantifies execution gaps within the organization. Moreover, the system 1000 achieves this, in some embodiments, by delivering actionable information in a timely manner for the executive team to make informed decisions to first stabilize the financial impact of an executable, and then to drive performance improvement via enterprise acceleration.

The system periodically analyzes the businesses 3 core data streams, these include but are not limited to the “FRONT” the customer facing interaction primarily at the point of purchase (POS System), the “CENTER” which includes the inventory sales floor, visual merchandising sets, price integrity and price file management, in stock—replenishment systems (Inventory Management Systems), and “BACK” identifies the inbound and outbound flow of product, such as from internal distribution centers, direct to store from vendor, traditional direct store delivery and/or drop shipped, or cross docked via a third party service provider, exclusive outbound flow is the RTV return to vendor processes, damage reclaim products for credit, and hazardous material processing.

The system 1000 then processes and analyzes the information sourced from the three core data streams. The system 1000 evaluates, using advanced machine learning to determine when, where and how executional gaps begin to appear within the three core sourced data streams. These gaps are categorized into one or more of the “P3” optimization pillars, which stands for “Platform,” “Protocol,” and “Process.”

Platform—these are the system(s) used by associates, vendor partners and customers when they interact with the business

Protocol—these are the policies and procedures governing the business, these include training materials, state & federal compliance standards, certifications, etc.

Process—the process(es) include the human interaction with the business, be they associates, vendor partners and customers

When the “P3” Risk Isolation pillars are aligned, the businesses expectations and outcomes are aligned. Risk is contained and profitability thrives. However, when one or more of the “P3” Risk Isolation pillars are in conflict with one or more of the other “P3” pillars, the business expectations and outcomes are in conflict typically resulting in a negative impact to the business financially, and/or a negative impact on the brand as a whole.

To summarize, the system 1000 provides visibility to business executables, which in turn provides the business with the capability to optimize the net contribution of ever revenue dollar received. Moreover, the system 1000 optimizes store support staffs span of control by isolating and quantifying those locations that are underperforming versus those locations that are at or better than budget financially and/or operationally from a productivity view.

The system 1000 sources information from three core data streams in this embodiment-1) Front -2) Center -3) Back; this data, depending on the classification type, it is processed in system 100; as daily data feed, weekly data feeds and/or monthly data feeds.

This information once processed and analyzed with in the system 1000. The analysis is structured to evaluate base line expectations of a series of leading indicators related to tasks, processes, activities, events and or interactions. The system 1000 further analyzes the outputs against prior historical performance to establish behavior patterns based a variety of internal and external factors to determine the expected performance output of the tasks, processes, activities, events and or interactions. When a leading indicator begins to negatively trend from expectations an alert is issued to the resource that is accountable for that executable.

The alert is a feature that provides a closed loop near time communication, which is sent to the business resource accountable for that task, process, activity, event and/or interaction. The alert provides a detailed summary of what the system has identified, and provides a step-by-step solution set to first validate the assessment and secondly what steps were taken to correct the executional gap as it relates to the P3 Risk Isolation strategy—Platform, Protocol and Process. Specifically, the alert could provide corrective action localized to a store, or could be a correction isolated to a district, a reporting region, a supply chain network, or an enterprise wide variant that requires added resources to remediate.

The corrective actions taken are documented in the system. These remediation steps are then analyzed to further refine the system's expectation related to the leading indicator being assessed and correlated by the system. These learnings are then re-indexed thru the adaptive isolation and quantification portal. This provides the system with feedback information to continually update and modify data parameters in order to maintain alignment between business expectations and business outcomes.

### EXAMPLES

Illustrative examples of the technologies disclosed herein are provided below. An embodiment of the technologies may include any one or more, and any combination of, the examples described below.

Example 1 includes a system for predicting retail enterprise deficiencies. The system includes a storage device having stored front store data, center store data, and back store data of a plurality of stores of a retail store enterprise, wherein the front store data comprises customer facing data at a point of purchase system, the center store data comprises data regarding one or more of inventory sales data, visual merchandising set data, price integrity data, price file management data, or inventory management system data, and the back store data comprises data representing inbound and outbound flow of products between one or more of internal distribution centers, direct to store shipments, or drop shipments. There is at least one processor coupled to the storage device, wherein the storage device stores a program for controlling the at least one processor, and wherein the at least one processor, being operative with the program, is configured to: create a plurality of machine learning (ML) models for predicting executional gaps regarding one or more of the front store data, center store data or back store data by analyzing training data representative of historical transactions concerning front store data, center store data and back store data of at least a portion of the plurality of stores of the retail store enterprise; score a plurality of leading indicators concerning the front store data, center store data and back store data as a function of respective stores in the retail store enterprise based on the plurality of ML models, wherein to score the plurality of leading indicators comprises predicting future performance regarding the plurality of leading indicators regarding the plurality of stores of the retail store enterprise; and generate a user interface highlighting one or more issues that need addressing based on the score of the plurality of leading indicators.

Example 2 includes the subject matter of Example 1, and wherein: to score the plurality of leading indicators comprises determining one or more scores based on predicted future performance by the plurality of ML models for at least a portion of the plurality of stores of the retail store enterprise.

Example 3 includes the subject matter of Examples 1-2, and further comprising applying weights to the scores of the plurality of leading indicators, wherein the weights are based on a correlation of each respective leading indicator to that respective store's performance.

Example 4 includes the subject matter of Examples 1-3, and wherein: to score the plurality of leading indicators comprises predicting future performance of the plurality of leading indicators based on the plurality of ML models as a function of one or more of (i) SKU, (ii) product category, or (iii) department.

Example 5 includes the subject matter of Examples 1-4, and further comprising determining a risk score for at least a portion of stores of the plurality of stores that indicates a prediction on a plurality of leading indicators by aggregating scores for the plurality of indicators for each respective store.

Example 6 includes the subject matter of Examples 1-5, and further comprising generating a heat map identifying relative risk scores for the plurality of stores.

Example 7 includes the subject matter of Examples 1-6, and wherein: the heat map identifies relative risk scores for the plurality of stores as a function of color.

Example 8 includes the subject matter of Examples 1-7, and further comprising sending an alert identifier identifying one or more stores of the plurality of stores based on a threshold risk score.

Example 9 includes the subject matter of Examples 1-8, and further comprising generating recommended remedies to address a predicted performance regarding a leading indicator.

Example 10 includes a method predicting retail enterprise deficiencies, the method comprising: creating a plurality of machine learning (ML) models for predicting executional gaps regarding one or more of a front store data, a center store data or a back store data by analyzing training data representative of historical transactions concerning front store data, center store data and back store data of at least a portion of the plurality of stores of the retail store enterprise; scoring a plurality of leading indicators concerning the front store data, center store data and back store data as a function of respective stores in the retail store enterprise based on the plurality of ML models, wherein to score the plurality of leading indicators comprises predicting future performance regarding the plurality of leading indicators regarding the plurality of stores of the retail store enterprise; and generating a user interface highlighting one or more issues that need addressing based on the score of the plurality of leading indicators.

Example 11 includes the subject matter of Example 10, and wherein: scoring the plurality of leading indicators comprises determining one or more scores based on predicted future performance by the plurality of ML models for at least a portion of the plurality of stores of the retail store enterprise.

Example 12 includes the subject matter of Examples 10-11, and further comprising applying weights to the scores of the plurality of leading indicators, wherein the weights are based on a correlation of each respective leading indicator to that respective store's performance.

Example 13 includes the subject matter of Examples 10-12, and wherein: scoring the plurality of leading indicators comprises predicting future performance of the plurality of leading indicators based on the plurality of ML models as a function of one or more of (i) SKU, (ii) product category, or (iii) department.

Example 14 includes the subject matter of Examples 10-13, and further comprising determining a risk score for at least a portion of stores of the plurality of stores that indicates a prediction on a plurality of leading indicators by aggregating scores for the plurality of indicators for each respective store.

Example 15 includes the subject matter of Examples 10-14, and further comprising generating a heat map identifying relative risk scores for the plurality of stores.

Example 16 includes the subject matter of Examples 10-15, and wherein: the heat map identifies relative risk scores for the plurality of stores as a function of color.

Example 17 includes the subject matter of Examples 10-16, and further comprising sending an alert identifier identifying one or more stores of the plurality of stores based on a threshold risk score.

Example 18 includes the subject matter of Examples 10-17, and further comprising generating recommended remedies to address a predicted performance regarding a leading indicator.

Example 19 is one or more non-transitory, computer-readable storage media comprising a plurality of instructions stored thereon that, in response to being executed, cause a computing device to: store front store data, center store data, and back store data of a plurality of stores of a retail store enterprise, wherein the front store data comprises customer facing data at a point of purchase system, the center store data comprises data regarding one or more of inventory sales data, visual merchandising set data, price integrity data, price file management data, or inventory management system data, and the back store data comprises data representing inbound and outbound flow of products between one or more of internal distribution centers, direct to store shipments, or drop shipments; create a plurality of machine learning (ML) models for predicting executional gaps regarding one or more of the front store data, center store data or back store data by analyzing training data representative of historical transactions concerning front store data, center store data and back store data of at least a portion of the plurality of stores of the retail store enterprise; score a plurality of leading indicators concerning the front store data, center store data and back store data as a function of respective stores in the retail store enterprise based on the plurality of ML models, wherein to score the plurality of leading indicators comprises predicting future performance regarding the plurality of leading indicators regarding the plurality of stores of the retail store enterprise; and generate a user interface highlighting one or more issues that need addressing based on the score of the plurality of leading indicators.

Example 20 includes the subject matter of Example 19, and wherein: to score the plurality of leading indicators comprises determining one or more scores based on predicted future performance by the plurality of ML models for at least a portion of the plurality of stores of the retail store enterprise.

1. A system for predicting retail enterprise deficiencies, the system comprising:
a storage device having stored front store data, center store data, and back store data of a plurality of stores of a retail store enterprise, wherein the front store data comprises customer facing data at a point of purchase system, the center store data comprises data regarding one or more of inventory sales data, visual merchandising set data, price integrity data, price file management data, or inventory management system data, and the back store data comprises data representing inbound and outbound flow of products between one or more of internal distribution centers, direct to store shipments, or drop shipments; and
at least one processor coupled to the storage device, wherein the storage device stores a program for controlling the at least one processor, and wherein the at least one processor, being operative with the program, is configured to:
create a plurality of machine learning (ML) models for predicting executional gaps regarding one or more of the front store data, center store data or back store data by analyzing training data representative of historical transactions concerning front store data, center store data and back store data of at least a portion of the plurality of stores of the retail store enterprise;
score a plurality of leading indicators concerning the front store data, center store data and back store data as a function of respective stores in the retail store enterprise based on the plurality of ML models, wherein to score the plurality of leading indicators comprises predicting future performance regarding the plurality of leading indicators regarding the plurality of stores of the retail store enterprise; and
generate a user interface highlighting one or more issues that need addressing based on the score of the plurality of leading indicators.

2. The system of claim 1, wherein to score the plurality of leading indicators comprises determining one or more scores based on predicted future performance by the plurality of ML models for at least a portion of the plurality of stores of the retail store enterprise.

3. The system of claim 2, further comprising applying weights to the scores of the plurality of leading indicators, wherein the weights are based on a correlation of each respective leading indicator to that respective store's performance.

4. The system of claim 2, wherein to score the plurality of leading indicators comprises predicting future performance of the plurality of leading indicators based on the plurality of ML models as a function of one or more of (i) SKU, (ii) product category, or (iii) department.

5. The system of claim 4, further comprising determining a risk score for at least a portion of stores of the plurality of stores that indicates a prediction on a plurality of leading indicators by aggregating scores for the plurality of indicators for each respective store.

6. The system of claim 4, further comprising generating a heat map identifying relative risk scores for the plurality of stores.

7. The system of claim 6, wherein the heat map identifies relative risk scores for the plurality of stores as a function of color.

8. The system of claim 6, further comprising sending an alert identifier identifying one or more stores of the plurality of stores based on a threshold risk score.

9. The system of claim 6, further comprising generating recommended remedies to address a predicted performance regarding a leading indicator.

10. A method of predicting retail enterprise deficiencies, the method comprising:
creating a plurality of machine learning (ML) models for predicting executional gaps regarding one or more of a front store data, a center store data or a back store data by analyzing training data representative of historical transactions concerning front store data, center store data and back store data of at least a portion of the plurality of stores of the retail store enterprise;
scoring a plurality of leading indicators concerning the front store data, center store data and back store data as a function of respective stores in the retail store enterprise based on the plurality of ML models, wherein to score the plurality of leading indicators comprises predicting future performance regarding the plurality of leading indicators regarding the plurality of stores of the retail store enterprise; and
generating a user interface highlighting one or more issues that need addressing based on the score of the plurality of leading indicators.

11. The method of claim 10, wherein scoring the plurality of leading indicators comprises determining one or more scores based on predicted future performance by the plurality of ML models for at least a portion of the plurality of stores of the retail store enterprise.

12. The method of claim 11, further comprising applying weights to the scores of the plurality of leading indicators, wherein the weights are based on a correlation of each respective leading indicator to that respective store's performance.

13. The method of claim 11, wherein scoring the plurality of leading indicators comprises predicting future performance of the plurality of leading indicators based on the plurality of ML models as a function of one or more of (i) SKU, (ii) product category, or (iii) department.

14. The method of claim 13, further comprising determining a risk score for at least a portion of stores of the plurality of stores that indicates a prediction on a plurality of leading indicators by aggregating scores for the plurality of indicators for each respective store.

15. The method of claim 14, further comprising generating a heat map identifying relative risk scores for the plurality of stores.

16. The method of claim 15, wherein the heat map identifies relative risk scores for the plurality of stores as a function of color.

17. The method of claim 15, further comprising sending an alert identifier identifying one or more stores of the plurality of stores based on a threshold risk score.

18. The method of claim 15, further comprising generating recommended remedies to address a predicted performance regarding a leading indicator.

19. One or more non-transitory, computer-readable storage media comprising a plurality of instructions stored thereon that, in response to being executed, cause a computing device to:
store front store data, center store data, and back store data of a plurality of stores of a retail store enterprise, wherein the front store data comprises customer facing data at a point of purchase system, the center store data comprises data regarding one or more of inventory sales data, visual merchandising set data, price integrity data, price file management data, or inventory management system data, and the back store data comprises data representing inbound and outbound flow of products between one or more of internal distribution centers, direct to store shipments, or drop shipments;
create a plurality of machine learning (ML) models for predicting executional gaps regarding one or more of the front store data, center store data or back store data by analyzing training data representative of historical transactions concerning front store data, center store data and back store data of at least a portion of the plurality of stores of the retail store enterprise;
score a plurality of leading indicators concerning the front store data, center store data and back store data as a function of respective stores in the retail store enterprise based on the plurality of ML models, wherein to score the plurality of leading indicators comprises predicting future performance regarding the plurality of leading indicators regarding the plurality of stores of the retail store enterprise; and
generate a user interface highlighting one or more issues that need addressing based on the score of the plurality of leading indicators.

20. The one or more non-transitory, computer-readable storage media of claim 19, wherein to score the plurality of leading indicators comprises determining one or more scores based on predicted future performance by the plurality of ML models for at least a portion of the plurality of stores of the retail store enterprise.
